(19) United States
(12) Patent Application Publication
(10) Pub. No.: US 2014/0312842 A1
(43) Pub. Date: Oct. 23, 2014

(54) COMBINATIONAL POWER SUPPLY ADAPTER DEVICE

(71) Applicants: CHUNG-HSIN LEE, TAIPEI (TW); GAVIN MCCALLA, NIGUEL, CA (US)

(72) Inventors: CHUNG-HSIN LEE, TAIPEI (TW); GAVIN MCCALLA, NIGUEL, CA (US)

(21) Appl. No.: 13/865,297

(22) Filed: Apr. 18, 2013

(51) Int. Cl. H02J 7/00

(52) U.S. Cl. CPC H02J 7/0042
USPC 320/110

(57) ABSTRACT

A combinational power supply adapter device mainly comprises a connecting seat and different models of battery holster. Symmetrical fasteners and symmetrical through holes are disposed on the connecting seat. A rectifier transformer circuit and sockets are disposed inside the connecting seat. Connecting terminals are disposed on the rectifier transformer circuit, and the connecting terminals are exposed from the through holes. Symmetrical electric conduction plates are disposed inside the battery holster. When using the combinational power supply adapter device, different models of batteries can be placed inside the battery holster with a shape corresponding to that of the batteries, the battery holster can be engaged and positioned above the connecting seat by the fastening of the fasteners, and the batteries can be recharged or used for providing electricity through the connecting terminals and the rectifier transformer circuit. Thereby, the different models of batteries can be recharged or used for providing electricity through the single connecting seat.

### BACKGROUND OF THE INVENTION

1. Field of Invention

The present invention relates to a combinational power supply adapter device and more particularly to a combinational power supply adapter device by which different models of batteries can be recharged or used for providing electricity through a connecting seat. Thereby, the charging and supply of power can be performed more conveniently.

2. Related Art

Currently, mobile power supply is commonly applied in charging mobile phones, tablet computers, rechargeable power tools and heated clothes. However, the afore-mentioned objects require different voltages, for examples, the voltage for mobile phones and tablet computers is 5V, the voltage for heated clothing is 7.4V, the voltage for rechargeable power tools is 12V or 15V. Different power supplies are required for supplying power for the different tools. Conventional batteries used for power supplies for rechargeable power tools have larger power capacity and therefore are adequate for charging various tools. However, because different tools require different voltages, a type of battery with a battery holster and a rectifier transformer circuit to form a power supply seat for supplying power for rechargeable power tools has been developed. The power supply seat transforms the voltage of 12V or 15V of the battery used for rechargeable power tools into 5V or 7.4V for charging mobile phones and tablet computers or heated clothing. However, the shapes of batteries for supplying power for different brands of rechargeable power tools are different, the battery holster is required to be equipped with a power supply compatible with the battery when the power supply is recharged or used for providing power by a user. Thus, the different types of power supply seats are not only troublesome for storing, it is also troublesome to use because the wrong ones may be mistakenly equipped. Therefore, a power supply adapter for charging or providing electricity of the present invention is provided to suit different models of batteries.

### SUMMARY OF THE INVENTION

A main objective of the present invention is to provide a combinational power supply adapter device by which different models of batteries can be recharged or used for providing electricity through a single power supply adapter; thereby, the charging and supply of power can be performed more conveniently.

The combinational power supply adapter device comprises a connecting seat and different models of battery holster. Symmetrical fasteners and symmetrical through holes are disposed on the connecting seat. A rectifier transformer circuit and sockets are disposed inside the connecting seat. Connecting terminals are disposed on the rectifier transformer circuit, and the connecting terminals are exposed from the through holes. Symmetrical electric conduction plates are disposed inside the battery holster. When using the combinational power supply adapter device, different models of batteries can be placed inside the battery holster, the battery holster can be engaged and positioned above the connecting seat by the fastening of the fasteners, and the batteries or tools can be recharged or provided with electricity by the rectifier transformer circuit through the connecting terminals. Thereby, the different models of batteries and the battery holster can be used for providing electricity through the single power supply adapter device.

The connecting seat of the combinational power supply adapter device comprises a top cover and a bottom cover. Symmetrical dissected holes are disposed on a lateral side of the top cover to form suspending pieces. The fasteners are extended from the suspending pieces in order that the fasteners have suitable elasticity in favor of fastening with the battery holster.

The present invention will become more fully understood by reference to the following detailed description thereof when read in conjunction with the attached drawings.

### BRIEF DESCRIPTION OF THE DRAWINGS

FIG. 1 is a perspective view of a combinational power supply adapter device according to an embodiment of the present invention;

FIG. 2 is a perspective view of a connecting seat of the combinational power supply adapter device;

FIG. 3 is an exploded perspective view of the connecting seat of the combinational power supply adapter device;

FIG. 4 is a perspective view of the combinational power supply adapter device being used;

FIG. 5 is a perspective view of the combinational power supply adapter device according to another embodiment of the present invention;

FIG. 6 is a perspective view of the combinational power supply adapter device being used according to the other embodiment of the present invention; and

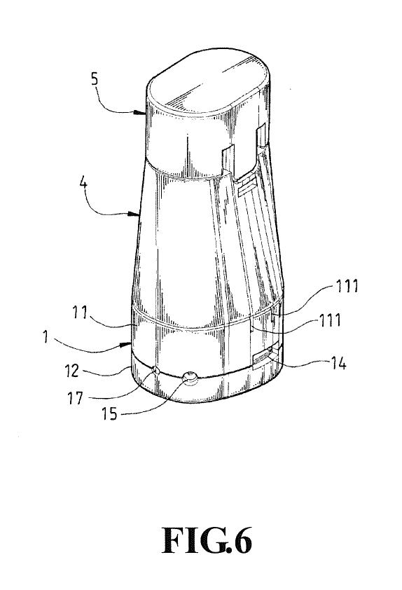

FIG. 7 is a perspective view of a conventional battery and battery holster.

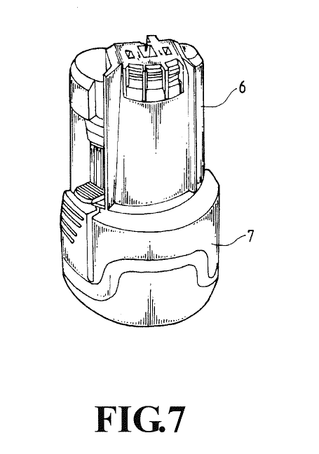

### DETAILED DESCRIPTION OF THE INVENTION

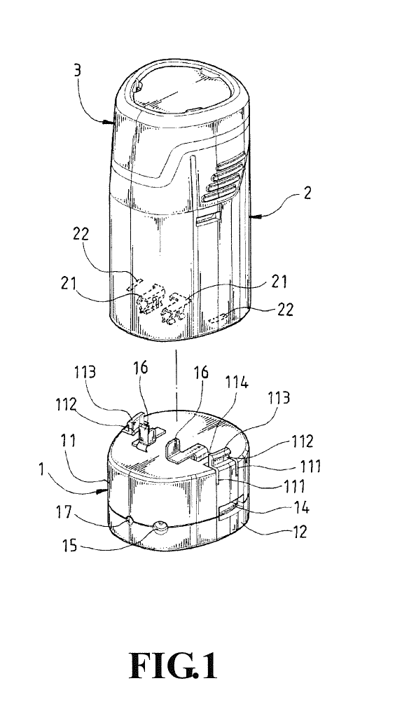

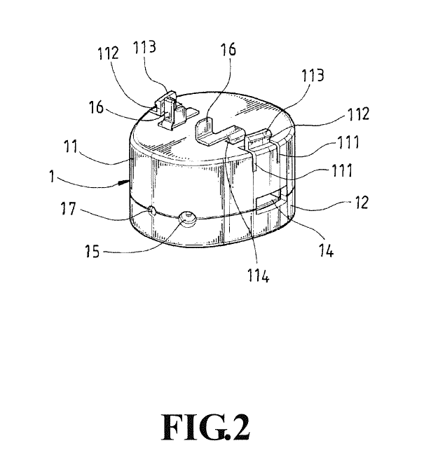

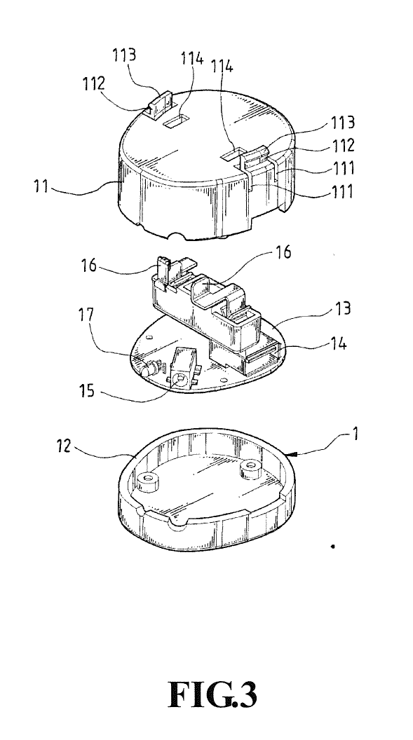

Please refer to FIGS. 1 and 2, which are a perspective view of a combinational power supply adapter device and a perspective view of a connecting seat, in conjunction with FIG. 3, which is an exploded perspective view of the connecting seat. As shown in the drawings, the combinational power supply adapter device comprises a connecting seat 1 and different models of battery holster 2. The connecting seat 1 comprises a top cover 11 and a bottom cover 12. Symmetrical dissected holes 111 are disposed on a lateral side of the top cover 11 to form suspending pieces 112. Fasteners 113 are extended from the suspending pieces 112 in order that the fasteners 113 have suitable elasticity. Symmetrical through holes 114 are disposed on the connecting seat 1 near inner sides of the fasteners 113 respectively. A rectifier transformer circuit 13 and sockets 14 and 15 connecting to the rectifier transformer circuit 13 are disposed inside the connecting seat 1. Connecting terminals 16 and an indicator light 17 (light emitting diode LED) are disposed on the rectifier transformer circuit 13. The sockets 14 and 15 and the indicator light 17 are exposed from the lateral side of the top cover 11, and the connecting terminals 16 are exposed upwardly from the through holes 114. Symmetrical electric conduction plates 21 are disposed inside the battery holster 2. Fastening holes 22 corresponding to the fasteners 113 of the connecting seat 1 are disposed on a bottom side of the battery holster 2.

Thereby, the combinational power supply adapter device is composed by the combinations of the above mentioned components. When using the combinational power supply adapter device, the different models of battery 3 can be sleeved inside the battery holster 2, and the battery holster 2 can be engaged and positioned above the connecting seat 1 by fastening the fasteners 113 with the fastening holes 22. Thereby, different models of the battery 3 can be recharged or used for providing electricity by the rectifier transformer circuit 13 through the connecting terminals 16 and the electric conduction plates 21.

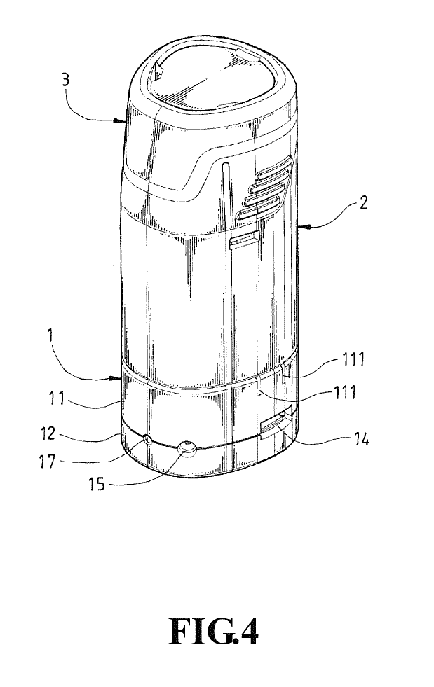

Please refer to FIG. 4, which is a perspective view of the combinational power supply adapter device being used, in conjunction with FIGS. 1 and 3. As shown in the drawings, when using the combinational power supply adapter device, the socket 14 or 15 of the connecting seat 1 is connected to a power source for charging or a tool for supplying power. The battery 3 is sleeved inside the battery holster 2 matching with the battery 3. Then, the battery holster 2 with the battery 3 is engaged with the connecting seat 1. During engaging, the fasteners 113 of the connecting seat 1 are pressed inwardly, so that the fasteners 113 can be spring back to their original positions and fastened with the fastening holes 22 to position the battery holster 2 after the fasteners 113 have passed through the fastening holes 22 on the bottom side of the battery holster 2. Thereby, the electric conduction plates 21 disposed inside the battery holster 2 can be gripped by the connecting terminals 16. Thus, power can be input or output by the rectifier transformer circuit 13 through the socket 14 or 15. At the same time, the indicator light 17 can be turned on through the connecting terminals 16 and the electric conduction plates 21 to indicate charging or supplying power.

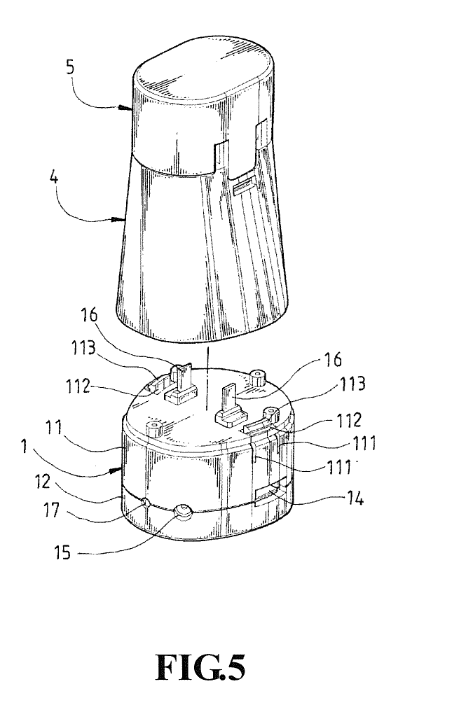

Please refer to FIG. 5. FIG. 5 is a perspective view of the combinational power supply adapter device according to another embodiment of the present invention. As shown in the drawing, another model of a battery holster 4 (in a trumpet shape with a wider bottom and a narrower top) is provided for another model of a battery 5 to sleeve inside the battery holster 4, and the battery holster 4 with the battery 5 can be engaged and positioned above the connecting seat 1 by fastening the fasteners 113 with the battery holster 4. The socket 14 or 15 can be connected to a power source or tool. The power is conducted to the battery 5 through the connecting terminals 16 after the voltage is regulated in order that the battery 5 can be recharged or the battery 5 can supply power for the tool by the socket 14 or 15 through the connecting terminals 16. Thereby, different models of the battery 5 can be recharged or used for providing electricity by the single power supply adapter device.

As a conclusion from the above, the connecting seat disposed with the rectifier transformer circuit and the connecting terminals is used in coordination with different models of the battery holster to form the combinational power supply adapter device. Thereby, different models of the battery can be recharged or used for providing electricity through the single power supply adapter device. Thus, it is free of troublesome for having to use different models of the power supply adapter device to match with different models of the battery, and the recharging and providing of power are made more convenient.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A combinational power supply adapter device, comprising:
a connecting seat and different models of a battery holster;
wherein, the connecting seat comprises a top cover and a bottom cover, symmetrical fasteners are disposed on a lateral side of the top cover, symmetrical through holes are disposed near inner sides of the fasteners respectively, a rectifier transformer circuit and connecting terminals connecting to the rectifier transformer circuit are disposed inside the connecting seat, the connecting terminals are exposed upwardly from the through holes, symmetrical electric conduction plates are disposed inside the battery holster, fastening holes corresponding to the fasteners of the connecting seat are disposed on a bottom side of the battery holster; and
when using the combinational power supply adapter device, different models of a battery being sleeved inside the battery holster, the battery holster being engaged and positioned above the connecting seat by fastening the fasteners with the fastening holes, the battery being recharged or a tool being provided with electricity by the rectifier transformer circuit through the connecting terminals and the electric conduction plates, thereby, the different models of battery being recharged or used for providing electricity through the single power supply adapter device.

2. The combinational power supply adapter device as claimed in claim 1, wherein symmetrical dissected holes are disposed on the lateral side of the top cover to form suspending pieces, the fasteners are extended from the suspending pieces in order that the fasteners have suitable elasticity.

3. The combinational power supply adapter device as claimed in claim 1, wherein sockets are connected to the rectifier transformer circuit, the sockets are exposed from connecting seat.

4. The combinational power supply adapter device as claimed in claim 1, wherein an indicator light is connected to the rectifier transformer circuit, the indicator light is exposed from connecting seat.

5. The combinational power supply adapter device as claimed in claim 4, wherein the indicator light is a light emitting diode.
